(19) United States
(12) Patent Application Publication
(10) Pub. No.: US 2002/0021000 A1
(43) Pub. Date: Feb. 21, 2002

(54) Photo album

(76) Inventor: Luciano Pimpini, Falconara Marittima (IT)

Correspondence Address: YOUNG & THOMPSON, 745 SOUTH 23RD STREET 2ND FLOOR, ARLINGTON, VA, 22202

(21) Appl. No.: 09/906,611

(22) Filed: Jul. 18, 2001

(30) Foreign Application Priority Data
Jul. 18, 2000 (IT) AN2000U000021

(51) Int. Cl. B42D 1/08

(52) U.S. Cl. 281/21.1

(57) ABSTRACT

The present invention refers to a photo album (1) suitable to contain a relatively large number of photographs printed through computers on pages (4) which are folded and combined with other pages (4) so as to form a block. The combination of said pages (4) is obtained through interposition between the external sides of two of said pages of a bi-adhesive relatively stiff paperboard, which has a basic weight ranging between 300 and 800 g/m [symbol] and which is shorter at least 1.5 mm than the pages (4) wherein the paperboard has inserted. The paperboard (6) can be made bi-adhesive through the combination of a bi-adhesive film with any one of the two sides of the paperboard or sticking on every one of said sides a dry adhesive. Preferably, the back 3 is joined to the covers 2 only for a short line.

### BACKGROUND OF THE INVENTION

The present invention refers to a photo album, particularly suitable to contain a relatively large number of photographs, in particular photographs printed through computers.

In the last years, techniques of photographic reproduction which employ computers to create images from digital signals, have been gradually imposing. The digital signals from which restore such images, are mostly acquired by special cameras, called “digicamera” or the like and the images can be printed with a computer, through a special printer on a special paper, whose name is “digital photographic paper”.

Since full page printings can be easily obtained, therefore it is becoming frequent the just described technique even for the reportages of exhibitions and/or ceremonies, which have always been collected in suitable photo albums, generally quite large and heavy. A tipical example of this type, are the photo album designed for the marriages, for which the biggest images are particularly appreciated.

So far the attempts made to create photo albums of such a type, wherein the pages open showing a single large image on a full page (as it happens, for example for the traditional photographs—realized on standard paper using the technique called offset—in some tourist booklets), are failed, or they have produced images of inferior quality, since it is very difficult to stick the back of the pages between them: the photographic paper consists of a polyethylene film as back support and therefore it is very difficult to stick and the pages, once stuck, do not exhibit an adequate thickness such to avoid the case where the page corrugates, generating the phenomenon of the bending; the film nevertheless does not allow a lasting and precise cohesion without defects on the surface of the image.

### SUMMARY OF THE INVENTION

All of these drawbacks can be brilliantly solved by this invention, relating to a photo album suitable to contain a number even large of photographs printed using photographic paper on pages which are folded by means of mechanical creasing wherein the images face inwardly and are each other combined joining the external sides lacking in images during the binding characterized in that the combination of said pages in the binding is obtained through interposition between said external sides of two of the said pages of a bi-adhesive relatively stiff paperboard.

Preferably, such paperboard has a basis weight ranging from 300 and 800 g/m² and said photographs are printed using computers.

### BRIEF DESCRIPTION OF DRAWINGS

The present invention will be now described in detail, taking as reference the enclosed drawing, wherein:

FIG. 1 shows a plan view of the photo album according to the present invention;

FIG. 2 shows a plan view of a page of the album according to the present invention, before the realisation of the album itself;

FIG. 3 shows a side view which highlights the junction of two pages of the said photo album according to the invention; and

FIG. 4 shows a side view which highlights some of the pages of the album according to the invention, after the junction.

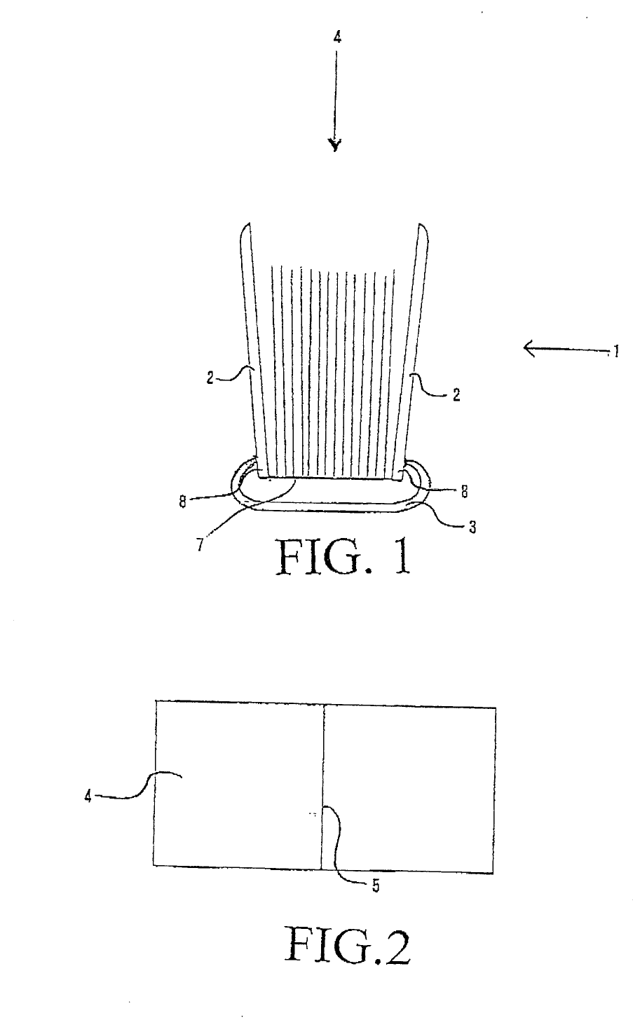

### BEST WAY OF CARRYING OUT THE INVENTION

An album 1, according to the present invention, is composed of cover plates 2, a back 3 and pages 4.

FIG. 2 shows a plan view of page 4. The page 4 has been printed through a special printer, with images on digital photographic paper. In the middle of page 4, an imaginary centre or division line 5, can represent the folding of page 4 by means of mechanical creasing and which will be called, just for simplicity sake, creasing 5.

In the assembled album, the pages are sticked interposing a paperboard 6 between them. The creasings 5 are entirely combined each other with a back 7.

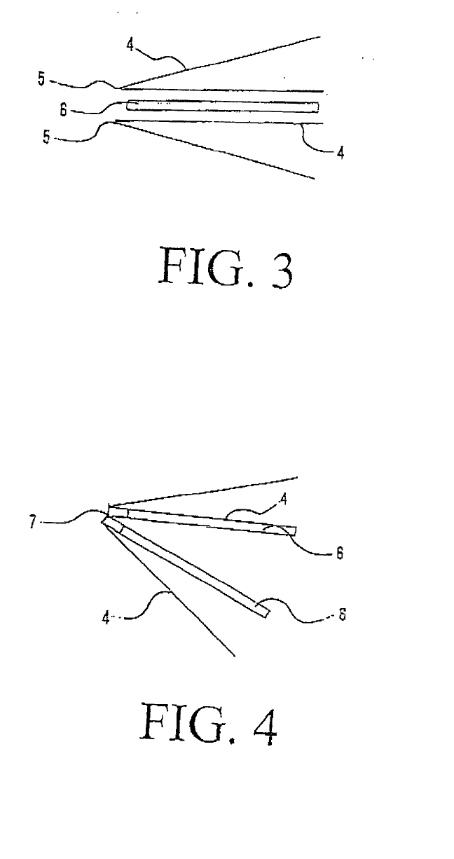

To produce the album 1 according to the invention, it is first necessary to print the image or the images on the full page 4. The page 4 is creased on the division line 5, taking care to let the image or the images facing inside. It follows a set of pages 4, each page folded with the images reciprocally placed side by side, as shown in FIG. 3. Two of these pages are combined, interposing between one of the back sides of the first and one of the back sides of the second a relatively stiff paperboard 6; the favourite basic weight is ranging between 300 to 800 g/m². Any one of the prior arts, such as, for example, that to combine any one of the sides of a paperboard with a dry bi-adhesive film, can make the paperboard 6 bi-adhesive. In this way, the external sides of the two pages 4 (see FIG. 3) are firmily stuck on the paperboard 6, meanwhile obtaining the stiffening. The process can be repeated as long as all the pages 4 of the album 1 have been combined so as form a block. The bi-adhesive layer on the paperboard 6 can be of all kinds, as long as it is smooth and compatible with the back support of the image. In particular a bi-adhesive film can be stuck on every one of the two sides of the paperboard or layers of adhesive can be applied on every one of the two sides, by means of silk-screen printing. It is preferable to employ adhesives which allow a dry combination, so as avoid the complicate steps of drying.

Advantageously, a distance ranging between 1.5 and 3 mm exists between the back 7 of the block of the pages 4 and the paperboard 6, so as avoid the contacts of the parties while leafing through the pages.

The following step represents the combination, among them, of the creasings 5 of all the pages 4 to form the back 7. The back gives to the block of the pages 4 a wider thickness and a better aesthetical effect, which can be also provided by applying a bi-adhesive tape on and placing on it a decorative fabric, for example a non-wowen fabric.

The question is, at this point, to combine the back so obtained with the cover plates 2 and with the back 3 of the album 1. The plates 2 can be combined as in any ones of the prior arts, so as leave, for example, the two flyleafs of the album lacking in images and stick them on the plates 2.

The album, can be stronger and easier to leaf through if the back 3 is effectively let separated from the and strip 8 of every one of the plates 2, rather than it is combined with them on all the contact surface. The said strip may have an ideal width ranging between 1 to 5 cm, preferably being of 3 cm.

The album according to the present invention therefore, allows to preview the photographs printed on photographic paper as on a vision effect, particularly suggestive for the images on full page.

The paperboard 6 makes the page 4 sufficiently stiff, so as the said page remains perfectly flat and can be leaf through and carried without causing any kind of damages at all.

Moreover, the said paperboard gives the album of an important and pleasant structure from the visual point of view.

An album of such a type allows the binding of about 50 pages 4 a time.

A particular pleasantness affect is obtained by using handmade leather covers; in this way the album 1 combines the modernity of the new technique of photographic reproduction with the skilled craft of binding and of leather manufacturing.

1) Photo Album (1) suitable to contain a number even relatively large of photographs printed using photographic paper, on pages (4) which are folded by means of mechanical creasing with the images facing inwardly and joined such to combine between them the external sides lacking in images in the binding characterized in that the combination of said pages (4) in the binding is obtained through interposition of a bi-adhesive relatively stiff paperboard (6) between said external sides of two of said pages.

2) Photo album (1) as in 1) characterized in that said photographs are printed by means of computers.

3) Photo album (1) as in claim 2), characterized in that said paperboard (6) has a basic weight ranging between 300 and 800 g/m².

4) Photo album (1) as in claim 3), characterized in that the paperboard (6) is made bi-adhesive sticking a bi-adhesive film on every one of its two sides.

5) Photo album (1) as in claim 3) characterized in that said paperboard is made bi-adhesive sticking on every one of its sides a dry adhesive.

6) Photo album (1) as in claim 3), characterized in that the back (3) is combined with the cover plates (2), so as leave separated a strip of extremity among them.

7) Photo album (1) as in claim 6), characterized in that the width of said strip ranges between 1 and 5 cm.

8) Photo album (1) as in claim 7) characterized in that the width of said strip is about 3 cm.

9) Photo album (1) as in claim 8), characterized in that a distance between the back (7) of the pages-pad and the paperboard (6) exists.

10) Photo album (1) as in claim 9) characterized in that said distance ranges between 1.5 and 3 mm.
